(19) United States
(12) Patent Application Publication
(10) Pub. No.: US 2016/0167661 A1
(43) Pub. Date: Jun. 16, 2016

(54) METHOD FOR OPERATING A DRIVER ASSISTANCE SYSTEM OF A MOTOR VEHICLE AND DRIVER ASSISTANCE SYSTEM FOR A MOTOR VEHICLE

(71) Applicant: AUDI AG, Ingolstadt (DE)

(72) Inventors: Marcus KUEHNE, Beilngries (DE); Johann SCHNEIDER, Wettstetten (DE)

(73) Assignee: AUDI AG, Ingolstadt (DE)

(21) Appl. No.: 14/906,246

(22) PCT Filed: Jul. 11, 2014
(86) PCT No.: PCT/EP2014/001916

§ 371 Date: Jan. 19, 2016

(30) Foreign Application Priority Data
Jul. 19, 2013 (DE) 102013012122.1

(51) Int. Cl. B60W 30/18

(52) U.S. Cl. CPC B60W 30/18163; B60W 2540/00

(57) ABSTRACT

A driver assistance system of a motor vehicle senses a line of vision of a driver of the motor vehicle and ascertains a lane change intention of the driver on the basis of the sensed line of vision so that the driver assistance system can take account of the ascertained lane change intention. The sensed line of vision is taken as a basis for ascertaining whether the driver has turned his eyes toward respectively prescribed mirrors of the motor vehicle in a first predetermined order or in a second predetermined order. When turning of the eyes in the first predetermined order has been ascertained, a lane change intention to the left is ascertained. When turning of the eyes in the second predetermined order has been ascertained, a lane change intention to the right is ascertained.

### CROSS REFERENCE TO RELATED APPLICATIONS

This application is based on and hereby claims priority to International Application No. PCT/EP2014/001916 filed on Jul. 11, 2014 and German Application No. 10 2013 012 122.1 filed on Jul. 19, 2013, the contents of both are hereby incorporated by reference.

### BACKGROUND

Described below are a method for operating a driver assistance system of a motor vehicle and a driver assistance system for a motor vehicle.

During the operation of a driver assistance system, early information concerning whether a driver is planning a lane change is sometimes of great importance. This is particularly the case when a driver assistance system that is used to assist or control the transverse guidance of the motor vehicle is concerned.

DE 10 2010 004 625 A1 shows a method for assisting a driver in an overtaking process. A sensed line of vision of a driver of the motor vehicle is taken as a basis for ascertaining a lane change intention of the driver, a driver assistance system of the motor vehicle being operated as appropriate taking account of the ascertained lane change intention.

DE 10 2010 041 620 A1 likewise shows a method for assisting a driver in an overtaking process. The method disclosed therein likewise involves a sensed line of vision of a driver of the motor vehicle being taken as a basis for ascertaining a corresponding lane change intention and a driver assistance system of the motor vehicle being operated as appropriate taking account of the ascertained lane change intention.

WO 2010045908 A1 shows a method for automatic direction-of-travel indication. A line of vision of a driver of the motor vehicle is ascertained and, on the basis thereof, a corresponding lane change intention of the driver is estimated on the basis of the sensed line of vision. The estimated lane change in intention is taken as a basis for corresponding activation of a direction-of-travel indicator of the motor vehicle.

DE 198 18 236 A1 shows an apparatus for monitoring a lane change for a motor vehicle. A sensed line of vision of a driver of the motor vehicle is taken as a basis for monitoring how long a driver has looked in a mirror of the motor vehicle before or during a lane change, and, if turning of the eyes toward the mirror is sensed to be too short, a corresponding warning signal is output.

### SUMMARY

Described below are a method and a driver assistance system of the type mentioned at the outset that are able to be used to sense a lane change intention of a driver in an improved manner.

The method described below for operating a driver assistance system of a motor vehicle includes:
sensing of a line of vision of a driver of the motor vehicle;
ascertainment of a lane change intention of the driver on the basis of the sensed line of vision;
operation of the driver assistance system taking account of the ascertained lane change intention;
   wherein the method is distinguished in that
the sensed line of vision is taken as a basis for ascertaining whether the driver has turned his eyes toward respectively prescribed mirrors of the motor vehicle in a first predetermined order or in a second predetermined order;
if turning of the eyes in the first predetermined order has been ascertained, a lane change intention to the left is ascertained;
if turning of the eyes in the second predetermined order has been ascertained, a lane change intention to the right is ascertained.

Thus, a corresponding lane change intention of the driver can be sensed on the basis of an appropriately detected and predetermined mirror glance pattern. This allows driver determination in respect of a lane change intention to be ascertained in particularly good time—specifically even before a lane change is initiated. In this case, the inventors recognized that a driver usually performs a correspondingly specific mirror glance pattern before actually initiating a lane change process, depending on whether a lane change to the left or to the right is planned. In other words, one and the same driver of the motor vehicle will usually always turn his eyes toward appropriate mirrors of the motor vehicle in the same order before he performs a lane change. Particularly as, according to the method, provision is made for a respectively detected mirror glance pattern to be attained as a basis for distinguishing whether the driver currently wishes to perform a lane change to the left or to the right, the corresponding driver assistance system can be supplied with appropriate information regarding the planned lane change in particularly good time, specifically even before the lane change is initiated. This allows a significant increase in traffic safety when driving the motor vehicle, since it means that the driver assistance system can take measures to increase traffic safety when driving the motor vehicle even before a lane change is actually performed.

According to one advantageous embodiment, the first predetermined order includes the driver having turned his eyes toward an interior mirror of the motor vehicle and subsequent turning of the eyes toward a left-hand exterior mirror of the motor vehicle. In addition, according to a further advantageous embodiment, the second predetermined order includes the driver having turned his eyes toward an interior mirror of the motor vehicle and subsequent turning of the eyes toward a right-hand exterior mirror of the motor vehicle. The reason is that a lane change is in most cases preceded by a first orientation glance in the rearview mirror and then in the relevant side mirror on whose side the lane change is meant to take place. From such a pattern in the form of the respective prescribed or predetermined orders and from matching of the sensed line of vision of the driver it is possible to identify an imminent lane change intention in very good time indeed, for example before a turn signal is actively given.

In a further advantageous embodiment, the respective lane change intention is ascertained only if the turning of the eyes in one of the respective predetermined orders has occurred within a prescribed period. Thus this because usually a driver of the motor vehicle will perform this mirror glance pattern within a particular period of time, for example within one second or even a few seconds or the like, if he should actually plan a lane change. This distinguishes particularly situations in which the driver casts a glance in the rearview mirror and then at one of the side of mirrors, for example within a longer period of time, for example 10 seconds or even more seconds. This again increases the reliability of the prediction of a corresponding lane change.

In a further advantageous embodiment, the prescribed period is conditioned on the basis of a current speed of the motor vehicle and/or a current speed limit. This is because when driving the motor vehicle particularly slowly, for example when driving in a town, it may be that the mirror glance pattern occurs within a longer period of time and, by way of example, when driving particularly fast on the freeway, the mirror glance pattern occurs within a much shorter period of time. This can be taken into account by appropriately conditioning the prescribed period on the basis of a current speed of the motor vehicle and/or a current speed limit, which means that the reliable prediction of a corresponding lane change can be increased again.

According to a further advantageous embodiment, the respective lane change intention is ascertained only if additionally a touch of a turn signal lever of the motor vehicle has been ascertained within a prescribed period of time before, during and/or after the respective turning of the eyes in one of the predetermined orders. This allows even greater accuracy to be attained for the prediction of such lane change determination, since, interaction with sensing of a touch of the turn signal by sensor, for example, it is possible for the previously estimated lane change intention to be verified. In a further advantageous embodiment, a lane change intention to the left is ascertained only if a touch on a top side of the turn signal has been ascertained. In a further advantageous embodiment, in addition, a lane change intention to the right is ascertained only if a touch on a bottom side of the turn signal lever has been ascertained. This means that in combination with matching of the respectively sensed mirror glance pattern it is possible for an even more reliable prediction of a corresponding lane change intention to the left or right to be made.

In a further advantageous embodiment, the ascertained lane change intention is taken into account for outputting at least one signal warning of the corresponding lane change if a prescribed hazard situation is sensed by the driver assistance system. The prescribed hazard situation may be, by way of example, a vehicle that is situated at least to some extent next to the motor vehicle in a lane that corresponds to the ascertained lane change intention, for example in the region of a blind spot or the like. Alternatively, the prescribed hazard situation may also be, by way of example, an approaching vehicle that is approaching the motor vehicle from behind in an adjacent lane that corresponds to the ascertained lane change intention and at least at a prescribed relative speed. The early identification or estimation of the lane change intention in combination with the output of a warning signal means that the driver is adverted to a potential hazard even before the actual lane change is performed, which can significantly increase traffic safety when driving the motor vehicle.

According to a further advantageous embodiment, the ascertained lane change intention is taken into account for the driver assistance system to prevent or hamper performance of the corresponding lane change while a prescribed hazard situation is sensed by the driver assistance system. By way of example, it may be possible for a lane change to be prevented completely while the hazard situation is present, for example by virtue of the driver assistance system being used to prevent the motor vehicle from being steered to the left or to the right. Alternatively, it is also possible for just a steering resistance to be increased while the hazard situation is sensed. This predictively prevents the driver from colliding with another vehicle approaching from behind or travelling next to the motor vehicle, for example, when changing lane.

The driver assistance system described below for a motor vehicle has an eye tracking device that is designed to sense a line of vision of a driver of the motor vehicle and to ascertain a lane change intention of the driver on the basis of the sensed line of vision. The driver assistance system additionally has a control device that is designed to operate the driver assistance system taking account of the ascertained lane change intention. The driver assistance system is distinguished in that the eye tracking device is designed to take the sensed line of vision as a basis for ascertaining whether the driver has turned his eyes toward respectively prescribed mirrors of the motor vehicle in a first predetermined order or in a second predetermined order. Furthermore, the eye tracking device is designed to ascertain a lane change intention to the left if turning of the eyes in the first predetermined order has been ascertained. In addition, the eye tracking device is designed to ascertain a lane change intention to the right if turning of the eyes in the second predetermined order has been ascertained. Advantageous embodiments of the method can be regarded as advantageous embodiments of the driver assistance system in this case, the driver assistance system includes components for performing the method.

### BRIEF DESCRIPTION OF THE DRAWINGS

Further advantages, features and details of the invention will become apparent from the description of preferred exemplary embodiments below and from the drawings. The features and combinations of features cited in the description above and the features and combinations of features cited in the description of the figures below and/or shown in the figures alone can be used not only in the respectively indicated combination but also in other combinations or on their own without departing from the scope of the invention.

Exemplary embodiments of the invention are explained in more detail below with reference to schematic drawings, in which:

FIG. 1 is a schematic illustration or block diagram of a motor vehicle having a sensing device that is designed to take a sensed line of vision of a driver of the motor vehicle as a basis for ascertaining a corresponding lane change intention;

FIG. 2 is a schematic illustration of a steering wheel, two exterior mirrors and an interior mirror of a motor vehicle, wherein a turn signal lever and a control stalk for controlling a cruise control of the motor vehicle are arranged on the steering wheel; and

FIG. 3 is a schematic plan view of a three-lane roadway, wherein the motor vehicle is travelling in the middle lane and further motor vehicles are travelling in the far left and far right lanes.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

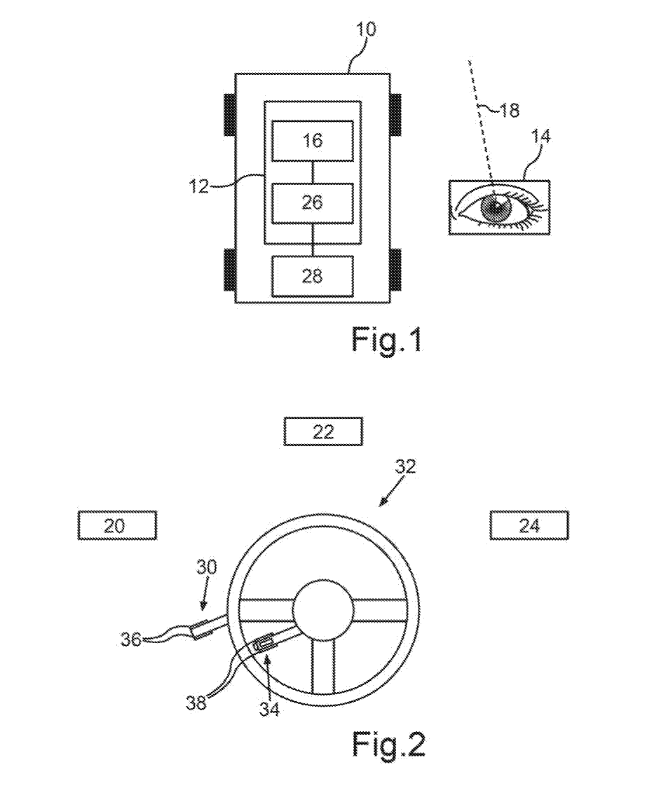

A motor vehicle 10 having a driver assistance system 12 is shown in a schematic illustration in FIG. 1. In the present case, the driver assistance system 12 is a lane change assistant that warns a driver 14 about impending collisions when changing lane or can also take action in the transverse guidance of the motor vehicle 10.

The driver assistance system 12 has an eye tracking device 16 that is designed to sense a line of vision 18 of the driver 14, which is denoted by the dashed line, and to ascertain a lane change intention of the driver 14 on the basis of the sensed line of vision 18. In this case, the eye tracking device 16 is designed to take the sensed line of vision 18 as the basis for ascertaining whether the driver has turned his eyes toward respectively prescribed mirrors 20, 22, 24, which are not shown in FIG. 1, in a first or second predetermined order. The eye tracking device 16 is designed to ascertain a lane change intention to the left if turning of the eyes in the first predetermined order has been ascertained. The eye tracking device 16 is additionally designed to ascertain a lane change intention to the right if turning of the eyes in the second predetermined order has been ascertained. Finally, the driver assistance system 12 also has a control device 26 that is designed to operate the driver assistance system 12 as appropriate taking account of the ascertained lane change intention.

The motor vehicle 10 additionally has a sensing device 28 that is designed to ascertain the lane change intention of the driver 14 additionally on the basis of an appropriately sensed touch of a turn signal lever 30, which is not shown here, this being explained in even more detail below.

An explanation is provided below with reference to FIG. 2, which shows a schematic illustration of a steering wheel 32 of the motor vehicle 10 and also the aforementioned mirrors 20, 22, 24. The aforementioned turn signal lever 30 and an operator control element 34, which is in the form of a control stalk, are arranged on the steering wheel 32. In the case shown here, the operator control element 34 is used to control a cruise control, which is not shown here, of the motor vehicle 10.

During operation of the driver assistance system 12, the eye tracking device 16 is used to continually sense the line of vision 18 of the driver 14 of the motor vehicle 10. The sensed line of vision 18 is taken as a basis for ascertaining whether the driver 14 has turned his eyes toward the respective mirrors 20, 22, 24 in a first predetermined order or in a second predetermined order.

The first predetermined order includes the driver 14 turning his eyes toward the mirror 22, which in the present case may be an interior mirror of the motor vehicle 10, and subsequent turning of the eyes toward the mirror 20, which is a left-hand exterior mirror of the motor vehicle 10 in the present case. The second predetermined order includes the driver turning his eyes toward the mirror 22 and subsequent turning of the eyes toward the mirror 24, which is meant to be a right-hand exterior mirror of the motor vehicle 10 in the present case.

If turning of the eyes in the first predetermined order has been ascertained, a lane change intention to the left is ascertained, and if turning of the eyes in the second predetermined order has been ascertained, a lane change intention to the right is ascertained. The respective lane change intention is ascertained only if the turning of the eyes in one of the respective predetermined orders has occurred within a prescribed period, for example one second, two seconds or the like. In this case, the prescribed period can be conditioned on the basis of a current speed of the motor vehicle 10 and/or a current speed limit of a road on which the motor vehicle 10 is currently travelling. By way of example, the prescribed period is set to a higher value when driving the motor vehicle 10 particularly slowly, for example when driving in a town, than when driving fast on a freeway.

In addition, provision may also be made for the respective lane change intention to be ascertained by the sensing device 28 only if additionally a touch of the turn signal lever 30 of the motor vehicle 10 has been ascertained within a prescribed period of time before, during and/or after the respective turning of the eyes in one of the predetermined orders. In the present case, the sensing device 28 has sensor units 36 arranged on the top side and the bottom side of the turn signal lever 30 and that can be used to sense, for example on the basis of pressure sensitivity or capacitance, a corresponding touch on a top side or on a bottom side of the turn signal lever 30. A lane change intention to the left is ascertained only if, in addition to the sensing of the relevant mirror glance pattern, a touch on a top side of the turn signal lever 30 has been ascertained. Similarly, a lane change intention to the right is ascertained only if a touch on a bottom side of the turn signal lever 36 has been ascertained within the prescribed period of time before, during and/or after the respective turning of the eyes in one of the predetermined orders.

In addition, provision may also be made for the lane change intention ascertained on the basis of the glance pattern to be verified by additionally using the sensing device 28 to ascertain or sense whether the driver 14 has possibly touched the operator control element 34 on its top side or on its bottom side, the sensing device 28 in turn being able to have appropriate sensor units 38 for this purpose. Should the driver 14 plan a lane change, for example, and inadvertently touch the operator control element 34 for controlling the cruise control instead of the turn signal lever 30, this is nevertheless taken as an indication that the driver 14, in combination with the sensed mirror glance pattern, has an extremely high probability of actually wanting to touch and later also actuate the turn signal lever 30, so that this is likewise used for additionally verifying the lane change intention ascertained on the basis of the sensed line of vision 18.

In addition, a respective appropriate profile for operating the driver assistance system 12 can be created on a driver basis. Continuous monitoring of the driver 14 can be taken as a basis for sensing and identifying relevant glance patterns and also actuating patterns for the turn signal lever 30 and the operator control element 34 that have been followed by the performance of an actual lane change by the driver 14 to the left or to the right. This information can be used to improve the ascertainment of corresponding lane change intentions of the relevant driver 14, which means that, by way of example, it is also possible to condition the aforementioned predetermined orders of instances of turning of the eyes or also additional combined orders of instances of turning of the eyes and instances of actuation of the turn signal lever 30 and/or the operator control element 34.

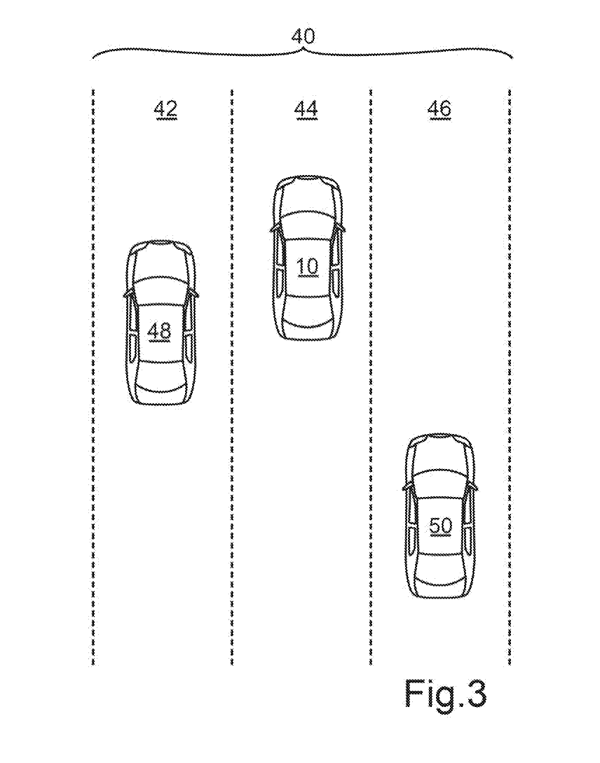

The operation of the driver assistance system 12 is explained in more detail below with reference to FIG. 3, which shows a roadway 40 having three lanes 42, 44, 46.

In the case shown here, the motor vehicle 10 is moving in the middle lane 44, with further motor vehicles 48, 50 travelling in the outer two lanes 42, 46. The driver assistance system 12 is used to influence the transverse guidance of the motor vehicle 10 taking account of the appropriately sensed lane change intention. Should it be sensed, by way of example, that the driver 14 wishes to perform a lane change with his motor vehicle 10 from the middle lane 44 to the left-hand lane 42, then in the case shown here a signal warning about the corresponding lane change is output, since the driver assistance system 12 is used to sense the motor vehicle 48, which is in the blind spot of the left-hand exterior mirror 20. Besides output of a purely warning signal, for example an audible signal and/or jolting of a steering wheel, the driver assistance system 12 can hamper or even prevent the performance of the corresponding lane change to the left by taking account of the ascertained lane change intention. By way of example, hampering of the lane change can be understood to mean that the steering resistance is increased to an appropriate extent while the motor vehicle 48 to the left of the motor vehicle 10 is sensed. Alternatively, it is also conceivable for the driver assistance system 12 to prevent the lane change to the left, so that the driver 14 cannot steer the motor vehicle 10 into the left-hand lane 42 at all, for example.

Should a lane change intention of the driver 14 to the right have been sensed instead, the driver assistance system 12 can also be operated for the lane change to the right in a manner similar to that for the planned lane change to the left. In the present case, there is a hazard situation owing to the approaching motor vehicle 50, since the latter is approaching the motor vehicle 10 in the right-hand lane 46 at elevated speed, that is to say at a very high relative speed. As soon as the lane change intention to the right has been sensed, the driver assistance system 12 senses a rear right-hand region of the motor vehicle 10, so that it is possible to sense in good time that the motor vehicle 50 is approaching in the right-hand outside lane 46 at elevated speed. Since a lane change intention to the right is assumed, the driver assistance system 12 will likewise output a warning signal, with the driver assistance system 12 additionally being able to hamper or even prevent the lane change to the right.

The explained method and the driver assistance system 12 mean that a planned lane change by a driver of a motor vehicle can be sensed in particularly good time and exactly. This means that a corresponding driver assistance system, particularly if used for assisting or controlling the transverse guidance of the motor vehicle, can be supplied with relevant information about a lane change that is very probably imminent in good time, so that the driver assistance system can assist, monitor or even fully automatically control transverse guidance of the motor vehicle in particularly good time.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. A method for operating a driver assistance system of a motor vehicle, comprising:
sensing a line of vision of a driver of the motor vehicle;
ascertaining a lane change intention of the driver based on the sensed line of vision, including
determining whether eyes of the driver have been turned toward respectively prescribed mirrors of the motor vehicle in one of a first predetermined order of an interior mirror and then a left-hand exterior mirror of the motor vehicle, and a second predetermined order of the interior mirror and then a right-hand exterior mirror of the motor vehicle;
detecting a touch of a turn signal lever of the motor vehicle within a first prescribed period of time at least one of before, during and after the turning of the eyes in one of the first and second predetermined orders, by sensor units arranged on a top side and a bottom side of the turn signal lever;
ascertaining a left lane change intention when turning of the eyes in the first predetermined order and a top touch on the top side of the turn signal lever have been ascertained; and
ascertaining a right lane change intention when turning of the eyes in the second predetermined order and a bottom touch on the bottom side of the turn signal lever have been ascertained; and
operating the driver assistance system by taking into account an ascertained lane change intention of the driver obtained by said ascertaining of one of the left lane change intention and the right lane change intention.

15. The method as claimed in claim 14, wherein the lane change intention is ascertained only if the turning of the eyes in one of the first and second predetermined orders has occurred within a second prescribed period of time.

16. The method as claimed in claim 15, wherein the second prescribed period of time varies based on at least one of a current speed of the motor vehicle and a current speed limit.

17. The method as claimed in claim 14, wherein said operating the driver assistance system includes outputting, in response to the ascertained lane change intention, at least one signal warning of a corresponding lane change when a prescribed hazard situation is sensed by the driver assistance system.

18. The method as claimed in claim 17, further comprising detecting, as the prescribed hazard situation, a vehicle situated at least to some extent next to the motor vehicle in an adjacent lane corresponding to the ascertained lane change intention.

19. The method as claimed in claim 17, further comprising detecting, as the prescribed hazard situation, an approaching vehicle that is approaching the motor vehicle from behind in an adjacent lane corresponding to the ascertained lane change intention and at at least a prescribed relative speed.

20. The method as claimed in claim 14, wherein said operating the driver assistance system includes, in response to the ascertained lane change intention, the driver assistance system one of preventing and hampering performance of the corresponding lane change while a prescribed hazard situation is sensed by the driver assistance system.

21. The method as claimed in claim 20, further comprising detecting, as the prescribed hazard situation, a vehicle situated at least to some extent next to the motor vehicle in an adjacent lane corresponding to the ascertained lane change intention.

22. The method as claimed in claim 20, further comprising detecting, as the prescribed hazard situation, an approaching vehicle approaching the motor vehicle from behind in an adjacent lane corresponding to the ascertained lane change intention and at at least a prescribed relative speed.

23. A driver assistance system for a motor vehicle having a turn signal lever, an interior mirror and left-hand and right-hand exterior mirrors, said driver assistance system comprising:
sensor units on top and bottom sides of the turn signal lever;
an eye tracking device sensing a line of vision of a driver of the motor vehicle and ascertaining a lane change intention of the driver based on the sensed line of vision, by
determining from the sensed line of vision whether eyes of the driver have been turned toward respectively prescribed mirrors of the motor vehicle in one of a first predetermined order of the interior mirror and then the left-hand exterior mirror, and a second predetermined order of the interior mirror and then the right-hand exterior mirror,
ascertaining a left lane change intention when turning of the eyes in the first predetermined order has been ascertained, and
ascertaining a right lane change intention when turning of the eyes in the second predetermined order has been ascertained; and
at least one sensing/control device operating the driver assistance system by taking into account an ascertained lane change intention of the driver provided by the eye tracking device, including
detecting a touch of the turn signal lever within a first prescribed period of time at least one of before, during and after the turning of the eyes in one of the first and second predetermined orders, by the sensor units arranged on the top side and the bottom side of the turn signal lever,
verifying the left lane change intention when a top touch on the top side of the turn signal lever has been detected, and
verifying the right lane change intention when a bottom touch on a bottom side of the turn signal lever has been detected.

24. The driver assistance system as claimed in claim 23,
further comprising an operator control element having additional sensor units on top and bottom sides, and
wherein the at least one sensing/control device also verifies the left lane change intention when a top touch on the top side of the operator control element has been detected, and verifies the right lane change intention when a bottom touch on a bottom side of the operator control element has been detected.
